(19) United States
(12) Patent Application Publication
(10) Pub. No.: US 2012/0273312 A1
(43) Pub. Date: Nov. 1, 2012

(54) SEPARATOR-SHOCK ABSORBER FOR TRANSPORTABLE LOADS

(76) Inventor: David-Israel MEDINA-ELIZONDO, Monterrey (MX)

(21) Appl. No.: 13/455,314

(22) Filed: Apr. 25, 2012

(30) Foreign Application Priority Data
Apr. 29, 2011 (MX) EMX/A/2011/004544

(51) Int. Cl. F16F 7/12

(52) U.S. Cl. 188/377

(57) ABSTRACT

A separator-shock absorber to avoid that charges which are going to be transported by land, by sea or by air collide and damage the loads collision to each other and damage the loads, and including: a retention base; a retention element near to a first end of the retention base; a separator-shock absorber member having a first articulated end and a second end to be coupled to the retention base; a retention element at the second end of the separator-shock absorber member, cooperating with the retention element of the first end of the retention base, in order to regulate the width of the separator-shock absorber member when it is articulated, to be coupled to the retention element of the retention base.

### FIELD OF THE INVENTION

This invention refers to a separator-shock absorber to avoid that the loads to be transported by land, by sea or by air collide and damage the loads.

### BACKGROUND OF THE INVENTION

Hitherto, when transporting risk loads which can be broken, crash or damage, such as bottles and articles of glass or other materials, or any other risk articles, and which usually are transported on pallets, bubbles plastic trips are used to independently surround the articles and relatively avoid that these loads be damaged by collision when are transported.

Balloons or air bags made of relatively resistant plastic have also been used introducing them between the loads to reduce the risk of damage of the loads by collision when transported.

However, the use of said bubbles plastic strips and air bags have the risk of leave the loads without protection, mainly by the changes of temperature and height above sea level, to which the loads are subjected to during its transportation, which may cause that the balloons and air bags unduly inflate or deflate to inconvenient limits and consequently do not suitable protect the load, causing breaking, crashing or damaging thereof.

Furthermore, the plastic air bags have to be produced in several dimensions because they cannot be graduated to be adjusted to diverse spaces between the loads without losing their inflation condition to resist collisions between the loads.

### SUMMARY OF THE INVENTION

It is therefore a main object of the invention, to provide a separator-shock absorber for transportable loads, which separates the loads to each other in order to absorb shocks among the loads during its natural movements when they are transported.

It is also a main object of the present invention, to provide a separator-shock absorber for transportable loads, of the above disclosed nature, which is resistant to heavy loads, for example pallets of 1 or 2 tons, protecting them and avoiding damages thereto due to its natural movements when transported.

It is a further object of the present invention, to provide a separator-shock absorber for transportable loads, of the above disclosed nature, which can be graduated as a function of the separation of its components and the separation of the loads to each other and of the diverse nature of the loads, to avoid that the loads be damaged due to the natural movement during its transportation.

These and other objects and advantages of the separator-shock absorber for transportable loads, of the present invention, will be apparent from the following detailed description of the specific embodiments of the invention, which are provided as an illustration but not as a limitation of the present invention and its scope will be defined exclusively by the accompanying claims, duly supported by this specification and by the accompanying drawings.

### BRIEF DESCRIPTION OF THE DRAWINGS

FIG. 1, is a conventional perspective view of a first embodiment of the separator-shock absorber for transportable loads, of the present invention, sowing a separator-shock absorber member is a curved way and an embodiment of articulation with a separator-shock absorber member;

FIG. 2, is a conventional perspective view of a second embodiment of the separator-shock absorber of the present invention, showing a different embodiment of retention base, of articulation elements between the retention base and a separator-shock absorber of two sections, forming a triangle;

FIG. 3, is a conventional perspective view of a third embodiment of the separator-shock absorber for transportable loads, of the present invention, assembled in a trapezoidal form:

FIG. 4, is a detailed conventional perspective view, of the articulation between the retention base and a separator-shock absorber member;

FIG. 5, is a partial top plant view of the second embodiment of the retention elements both in the retention base as in a separator-shock absorber; and

FIG. 6, is a partial top plant view of a third embodiment of the retention elements both in the retention base as in a separator-shock absorber.

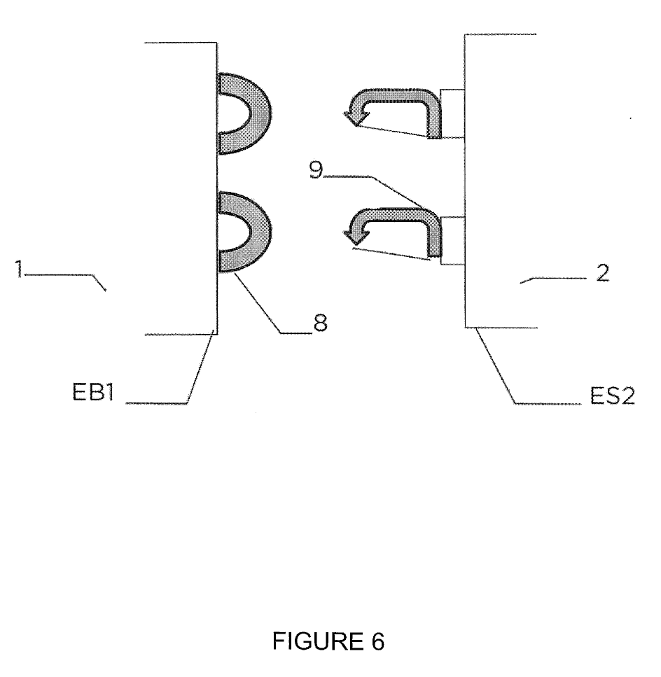

### DESCRIPTION OF THE PREFERRED EMBODIMENTS OF THE INVENTION

In the following the invention will be described making reference to the accompanying drawings, in which the same signs refer to the same parts of the shown figures, and wherein:

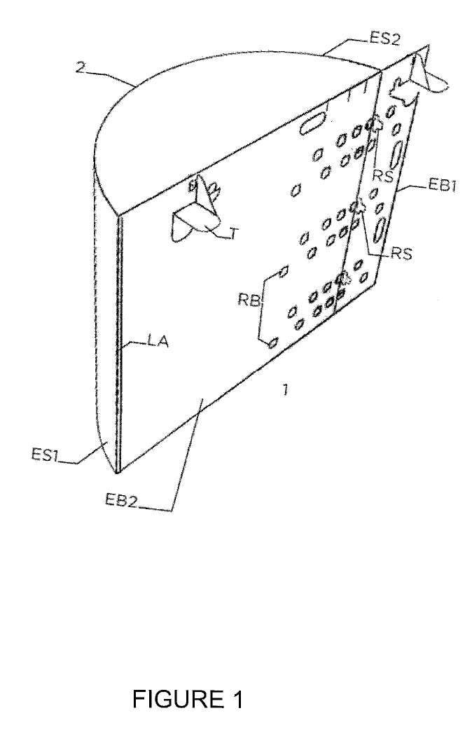

In a first embodiment of the separator-shock absorber, of the present invention, to be placed between transportable loads in order to separate them and avoid collision to each other, shown in FIG. 1 of the accompanying drawings, comprising: a retention base 1 having a first end EB1 and a second end EB2; retention elements shown in this embodiment as retention grooves or recesses RB, near to the first end EB1 of the retention base 1; a separator-shock absorber member 2 having a first end ES1 articulated at the second end EB2 of the retention base 1 and a second end ES2; retention elements shown as retention tongs RS at the second end ES2 of the separator-shock absorber member, cooperating with the retention recesses RB of the first end EB1 of the retention base 1, in order to regulate the width of the separator-shock absorber member 2 when it is articulated in the end EB2 of the retention base 1, to be coupled to the retention recess RB of the retention base 1.

The retention base 1 can include marks having diverse measuring scales, to graduate the distance between the diverse retention recesses RB and providing the width and dimensions of separation and cushioning between the loads.

When the separator-shock absorber of the present invention is made of resistant cardboard the separator-shock absorber member 2 is integrally articulated, by its first end ES1 to the second end EB2 of the retention base 1 by means of an articulation line LA (FIG. 1) pressed or stamped at the second end EB2 of the retention base 1. In this case, the separator-shock absorber member 2 is made from a sheet integral to the retention base 1 which is curved, as shown in said FIG. 1, to insert its retention tongs RS into the retention recesses RB of the retention base 1 and be place in a vertical position orienting the curved portion of the separator-shock absorber member 2 placed between the loads. In this embodiment the retention recesses can include commercially available prefabricated retention recesses, usually of plastic, insertable into the retention grooves or recesses RB.

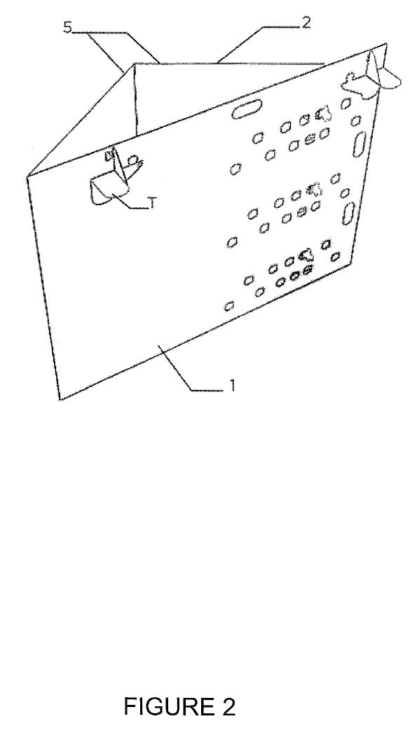

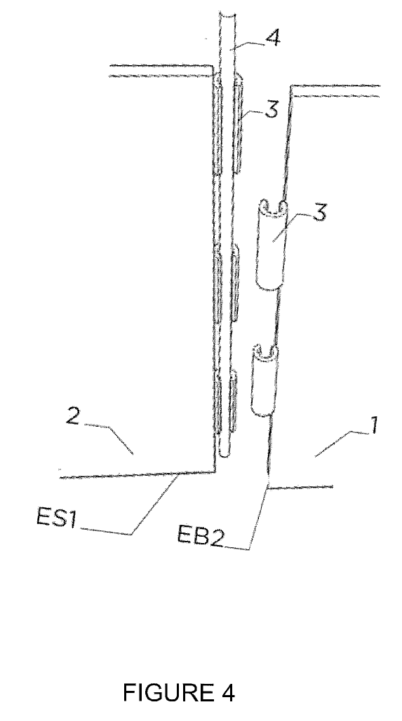

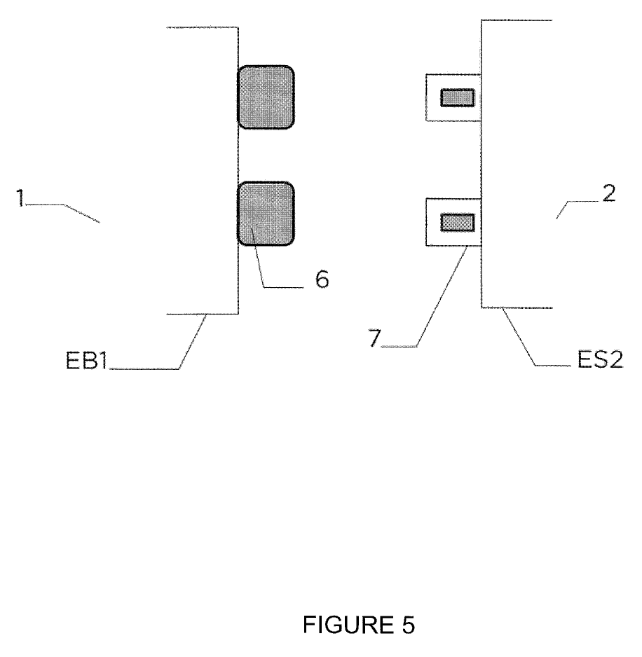

Or else, when the separator-shock absorber of the present invention is made of rigid plastic, wood or metal, the separator-shock absorber member 2 is articulated, by its first end ES1 to the second end EB2 of the retention base 1, by means of a hinges 3 and pins 4 assemblies as shown in FIG. 2 and FIG. 4, which articulately retain the separator-shock absorber member 2 to said second end EB2 of the retention base 1. In this case, said separator-shock absorber 2 comprises two or more sheets 5 of plastic, wood or metal articulated to each other by means of additional hinges 3 and pins 4 assemblies; and the retention recesses RB of the first end ER1 of the retention base 1 are substituted by buckles 6 and the retention tongs RS of the second end ES2 of the separator-shock absorber member 2, are substituted by perforated plates 7 as shown in detail in FIG. 5 or else, the buckles 6 and perforated plates 7, are substituted by rings 8 and the buckles 6 are substituted by a hook with latch 9 which hold the rings 8 in order to retain the separator-shock absorber member 2 at the required distance to separate the loads (not illustrated) and cushioning its movements during transportation thereof.

Both, the retention recesses RB or rings of the retention base 1, as the tongs RS or hook with latch 9 of the separator-shock absorber member 2 are distributed at diverse distances to each other in order to regulate the desired width of the separator-shock absorber member 2.

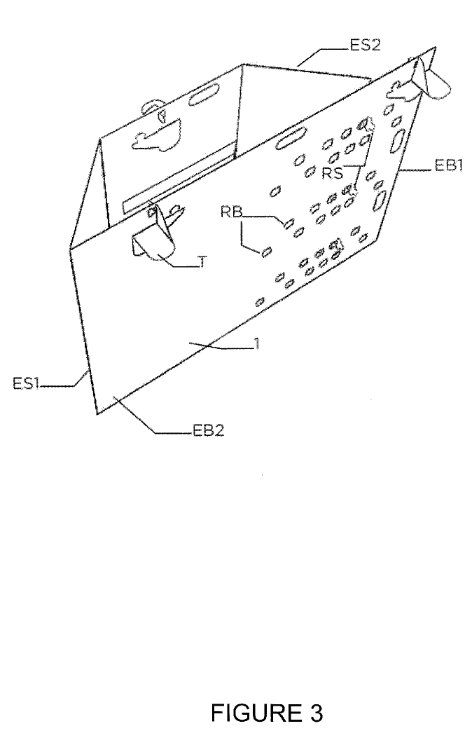

When the separator-shock absorber member consists of two or more sheets of any suitable material, depending on the number thereof, will form a triangle as in FIG. 2, trapeze as in FIG. 3, rectangle or any other polyhedron figure regarding the retention base.

The separator-shock absorber member may include a device in an inverted T shape presenting a flat section directed downwards in order to be retained in the top edge of the loads.

Furthermore, it is possible to manufacture two separator-shock absorbers in a single integral or articulated piece in order to place one adjacent and opposite to the other so that remain opposed to each other (not illustrated).

Although the above description includes many specifications, these should not be construed as limitative of the scope of the invention, but as illustrations provided regarding the currently preferred embodiments of this invention.

Therefore, the scope of the invention should be determined by the accompanying claims of the formal application and its legal equivalents instead of only the described embodiments.

I claim:

1. A separator-shock absorber to be placed between transportable loads in order to separate them and avoid collision to each other, comprising: a retention base having a retention base having a first end and a second end; retention means near to the first end of the retention base; a separator-shock absorber member having a first end articulated to the second end of the retention base and a second end; retention means at the second end of the separator-shock absorber member, cooperating with the retention means of the first end of the retention base, in order to regulate the width of the separator-shock absorber member when it is articulated, to be coupled to the retention means of the retention base.

2. The separator-shock absorber, as claimed in claim 1, wherein the retention base comprising a measuring scale corresponding to diverse distances of its retention means which define the width or separation distance or cushioning between the loads.

3. The separator-shock absorber, as claimed in claim 1, wherein the separator-shock absorber is integrally articulated to the second end of the retention base.

4. The separator-shock absorber, as claimed in claim 1, wherein the separator-shock absorber member is articulated to the second end of the retention base by means of hinges and pins assemblies which articulately retain the separator-shock absorber member to said second end of the retention base.

5. The separator-shock absorber, as claimed in claim 1, wherein the separator-shock absorber is semi circularly curved for coupling its retention means to the retention base, to provide a cushioning space between the loads.

6. The separator-shock absorber, as claimed in claim 1, wherein the separator-shock absorber comprising two or more sections articulated to each other , a first thereof starts from its first end and a free end of a last section comprising the retention means of this separator-shock absorber.

7. The separator-shock absorber, as claimed in claim 1, wherein separator-shock absorber includes an inverted T shape device presenting its flat section directed downwards in order to be retained in the top edge of the loads.

8. The separator-shock absorber, as claimed in claim 1, wherein the retention means of the retention base comprising a plurality of retention means distributed at diverse distances to each other, in order to regulate the desired width or separation between the loads, of the separator-shock absorber member.

9. The separator-shock absorber, as claimed in claim 1, wherein the retention recesses of the retention base comprising prefabricated retention recesses made of plastic or other material, to be inserted in the retention grooves or recesses.

10. The separator-shock absorber, as claimed in claim 1, wherein the retention members of the retention base and the retention members of the separator-shock absorber member cooperating to each other as a male-female way, so that retain the separator-shock absorber member at the desired distance to provide a desired width.

11. The separator-shock absorber, as claimed in claim 1, wherein the retention base and the separator-shock absorber member, are manufactured as a one single piece made of paperboard or plastic, and the separator-shock absorber member is articulated to the second end of the retention base by means of a stamped articulation line between the second end of the retention base and the first end of the separator-shock absorber member.

12. The separator-shock absorber, as claimed in claim 1, wherein the retention base and the separator-shock absorber member are manufactured as a one single piece made of paperboard or plastic, and the separator-shock absorber member is relatively flexible to be curved in order to be coupled to the retention means of its second end, with the retention means of the first end of the retention base.

13. The separator-shock absorber, as claimed in claim 1, wherein the retention base and the separator-shock absorber member are made of paperboard, plastic or metal, and the retention base and separator-shock absorber member are articulately coupled to each other by means of hinges and pins assemblies, and the separator-shock absorber member comprising two or more sections articulated to each other, a first of which starts from its first end and a free end of the last section comprising the retention means of this separator-shock absorber.

14. The separator-shock absorber, as claimed in claim 1, wherein the separator-shock absorber member comprising two sections which are articulated to each other to form a triangle with the retention base when coupling its retention means.

15. The separator-shock absorber, as claimed in claim 1, wherein the separator-shock absorber member comprising three sections which are articulated to each other to form a trapezium with the retention base when coupling its retention means.

16. The separator-shock absorber, as claimed in claim 1, wherein separator-shock absorber member comprising more than three sections which are articulated to each other to form a polygon with the retention base when coupling its retention means.

17. The separator-shock absorber, as claimed in claim 1, wherein the separator-shock absorber member comprising a plurality of apertures and the retention means of the separator-shock absorber member comprising a plurality of tongs to be introduced into the apertures of the retention base.

18. The separator-shock absorber, as claimed in claim 1, wherein then retention means of the retention base comprising a plurality of retention stops and the retention means of the separator-shock absorber member comprising a plurality of tongs for retaining abut against the apertures of the retention base.

19. The separator-shock absorber, as claimed in claim 1, wherein the retention means of the retention base, comprising a plurality of retention rings and the retention means of the separator-shock absorber member comprising a plurality of retention buckles or bars or retention hooks with latch which are introduced into retention bars of the retention base

20. The separator-shock absorber, as claimed in claim 1, wherein two separator-shock absorber members to be placed one adjacent to the other so that remain opposite to each other.
